(19) United States
(12) Patent Application Publication
(10) Pub. No.: US 2011/0004664 A1
(43) Pub. Date: Jan. 6, 2011

(54) Device and Method for Distributing and Forwarding Requests to a Plurality of Web Servers in an Industrial Automation Arrangement

(75) Inventors: Harald Herberth, Oberasbach (DE); Frank Volkmann, Nurnberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/829,777

(22) Filed: Jul. 2, 2010

(30) Foreign Application Priority Data
Jul. 3, 2009 (EP) EP09008762

(51) Int. Cl. G06F 15/16

(52) U.S. Cl. 709/206; 709/245

(57) ABSTRACT

A device and a method for distributing and forwarding requests to a plurality of web servers in an industrial automation arrangement. The device is configured to receive requests addressed to a well-known port, and the web servers are addressable by at least one local address and by means of one port number. The device is also configured to evaluate the destination URLs of the requests, where each of the requests have the same host header of the request and the server addressing components of the destination URLs are possibly identical, a path component of the URL in each case defines one of the web servers, and the device is configured to forward the request to one of the web servers defined by the path information.

### BACKGROUND OF THE INVENTION

1. Field of the Invention

The invention relates to data distribution and, more particularly, to a method and device for distributing and forwarding requests to a plurality of web servers in an industrial automation arrangement.

2. Description of the Related Art

In automation equipment and arrangements, components and equipment frequently communicate by the Transmission Control Internet (TCP/IP) protocol and other network protocols known from the Internet. Apart from the mere exchange of automation-related data, i.e., the transmission of measurement values and commands/instructions, these so-called “web technologies” in many cases are also used for linking observation and operation stations, i.e., Human-Machine Interfaces (HMI). Here, automation-related devices are frequently equipped with “web servers”, i.e., programs which provide data and information such that the automation-related devices can be accessed by requests in accordance with the Hyper Text Transfer Protocol (HTTP) and similar protocols, such as the Hyper Text Transfer Protocol Secure (HTTPS). Since these web servers, in principle, are set up by installing software or a software package on a hardware platform, it is also possible to operate several such web servers synchronously on the same hardware platform.

If a number of applications each having their own web server are installed on a personal computer (PC) or on a server, this leads to the problem that all these web servers each have to use their own TCP/IP port to be accessible to requests. As a result, the problem arises that there is only one reserved “well-known port” for web servers, i.e., the port having the number 80.

In conventional systems, this problem is solved, for example, by using a number of (private or dynamic) port numbers for addressing the various web servers on a machine. Since these port numbers are private, i.e., not “well-known”, a user (client) or his web browser or browser-like application must be informed about a port number deviating from the “standard”. A further disadvantage results from the fact that such ports, which do not correspond to the standard in most cases, are blocked or unsupported by conventional firewall devices and by conventional proxy servers so that in most cases such solutions can only be applied in private LANs.

A further possibility of enabling a plurality of web servers to be addressed on a “machine” consists in using so-called transcoders or reverse proxies. In this arrangement, a central web server, i.e., a portal web server, is used which itself requests the pages requested by a client from the lower-level web servers. Before these pages and other information items are sent to the requesting client, these information items are transcoded, i.e., all references (e.g., hyperlinks) to the original web server (lower-level web server), are converted such that, in cases in which the client later requests these references, the requests are not sent to the lower-level web server. Instead, these requests are resent to the portal web server. Moreover, in this technology the requests must also contain data by which the portal web server can decide to which of the lower-level web servers the respective request is to be forwarded. Disadvantages of this method reside in the high complexity of the transcoders. When certain technology is used, such as JavaScript or Ajax, the technology of the transcoded information is normally incompatible, because the program code would then have to be analyzed in each case.

### SUMMARY OF THE INVENTION

It is therefore an object of the present invention to provide a device and a method for distinguishably addressing a plurality of web servers to which an identical host name or an identical host IP address is allocated.

This and other objects and advantages are achieved in accordance with the invention by providing a device (e.g., a “dispatcher web server”) which can be reached (i.e., “addressed”) over a network through a well-known (i.e., public) port, preferably the port having the number 80. In accordance with the invention, the device is intended to distribute unchanged incoming requests to lower-level web servers or to forward them to these lower-level web servers, respectively. Since all lower-level web servers can be installed on the same machine, in every case a request always has the same host component in its destination Uniform Resource Locator (URL), independently of which one of the lower-level web servers the request is intended for. In accordance with the invention, a path component of the destination URL is used for distinguishing the lower-level web servers. The URLs of the lower-level web servers thus only need to be disjoint with regard to their path component.

The objects in accordance with the invention are achieved, in particular, by providing a device for distributing and forwarding requests to a plurality of web servers in an industrial automation arrangement, where the device is configured to receive the requests addressed to a well-known (i.e., public) port and the web servers are addressable by at least one local address and, in each case, by one port number. The device is also configured to evaluate the destination URLs of the requests, the requests in each case possibly having the same host header of the request, the server addressing components of the URLs possibly being identical, and a path component of the URL in each case defining one of the web servers. Moreover, the device is configured to forward the request to one of the web servers defined by the path information.

By using such a device, a plurality of web servers can be integrated on the same hardware platform, all of these web servers being accessible through the public port (i.e., port 80). Consequently, there are no restrictions with regard to the use of firewalls proxy servers, and the like, and requesting web browsers are able to address their requests to the public port.

The object of the invention is also achieved by a method for distributing and forwarding requests to a plurality of web servers in an industrial automation arrangement. In the first step, the device receives a request addressed to a public port and, in a second step, the device evaluates the destination URL contained in the request, where the device identifies one of a plurality of web servers as the destination of the request by the path component of the URL and the device subsequently forwards the request to the identified one of the web servers. The method in accordance with the invention also provides for unambiguous addressing of those web servers that are installed on the same host or have the same host component in their URL.

In preferred embodiments, the device forwards the request messages unchanged to the correspondingly identified one of the web servers. As a result, possible errors and expenditure on transcoding can be avoided. That is, the content of the requests and messages does not need to be altered.

For addressing the web servers, IP port numbers of private or dynamic ports are preferably used which ensures that no public ports used in other ways are blocked. In one advantageous embodiment, some or all of the web servers are installed on a common hardware platform. As a result, it is possible to avoid, for example, the requirement to assign a plurality of IP addresses (i.e., one for each one of the web servers) to the network interface of this hardware platform (“machine”). In addition, the web servers are advantageously addressable with the local host address (IP address 127.0.0.1). Such a scenario applies to the advantageous embodiment of the invention in which the device is installed on a common hardware platform with some or all of the web servers. As a result, the data traffic between the device and the web servers can be handled internally in the “machine” without using resources of the network. Furthermore, security can be increased as a result (“security aspect”) since the individual web servers do not need to be accessible directly out of the network.

Advantageously, the IP port having the number 80 is used as the public port because this is the public port to which clients (e.g., web browsers) usually address their requests. Analogously, the public port having the number 443 is advantageously used for this purpose for the HTPPS protocol.

The device is advantageously configured to forward those requests which do not or do not unambiguously provide for addressing by the path component of the destination URL to a predefined one of the web servers. This ensures those requests which are not addressed “correctly” are still answered. In one advantageous embodiment, the device itself can be this predefined web server.

To provide for bidirectional data traffic, the device is advantageously configured to forward response messages of the web servers to requests previously forwarded to the web servers to a network used and thus to an originally requesting client. For this purpose, the device uses conventional known procedures, for example, with the aid of so-called routing tables in which the requests previously forwarded to the web servers are logged.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the text which follows, exemplary embodiments of the method and device in accordance with the invention are explained by way of the drawings, in which:

FIG. 1 is an illustration of a schematic block diagram hardware platform, connected to a network, with the device and three “lower-level” web servers in accordance with the invention; and

FIG. 2 is a flow chart of a method in accordance with an embodiment of the invention.

### DETAILED DESCRIPTION OF THE PRESENTLY PREFERRED EMBODIMENTS

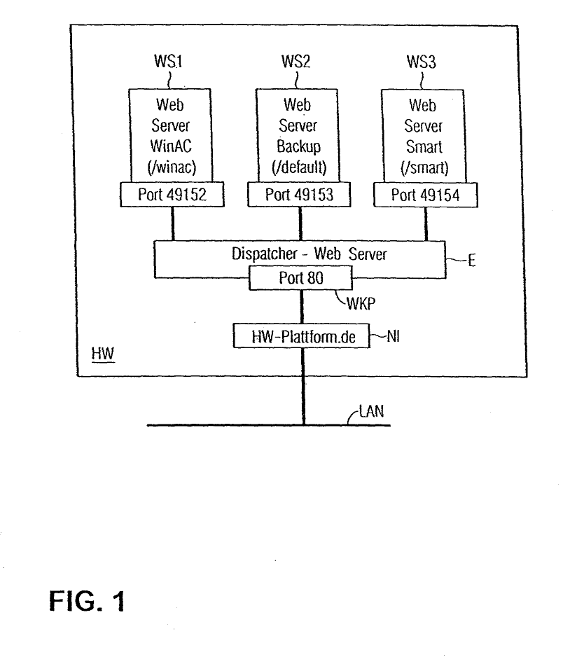

With reference to FIG. 1, a hardware platform (HW) is diagrammatically shown which, in the present exemplary embodiment, is an automation-related component having several functions. The hardware platform (HW) is connected to a network LAN by a network interface (NI) (e.g., a “Network Card” or a LAN Interface). In the present exemplary embodiment, the network interface (NI) is mainly used for exchanging protocol-compliant messages in accordance with the TCP/IP protocol. With a bidirectional software interface, i.e., a socket of the network interface (NI), the device E (“dispatcher web server”), as described in the text which follows, is connected and uses the public port WKP having the number 80 for the software interface. This public port (WKP) having the number 80 is allocated to the service HTTP which is offered by the “lower-level” web servers (WS1, WS2, WS3) also shown in the figure. These web servers (WS1, WS2, WS3) are logically connected to the device (E) through private IP ports having the numbers 49152, 49153, 49154 by a so-called local host address, i.e., internally in the hardware platform (HW). In each case, this local host address having the IP address 127.0.0.1, together with the respective private IP port number, forms the internal logical address of the web servers (WS1, WS2, WS3). While the exemplary embodiments listed here relate to the IPv4 protocol, it should be noted that the contemplated embodiments of the invention can also be used in IPv6 networks.

The web servers (WS1, WS2, WS3) have different functions for the automation-related arrangement which is considered in this case. Here, the web server (WS1), for example, is allocated to an automation-related control unit (“WinAC”) designed as software and capable of running under the Microsoft Windows operating system. The web server (WS3) is allocated to an application having the name (“Smart”). Moreover, the web server (WS2) (“Backup”) is allocated to a general information system which, among other things, is to be contacted when requests cannot be allocated in other ways.

In the text which follows, it shall be assumed that another type of automation-related component (not shown), i.e., a client, calls up a starting page of the web server (WS1). For this purpose, the following exemplary request is sent to the hardware platform (HW) over the network LAN:

GET/winac/index.html HTTP/1.1

Host: www.hw-plattform.de

Connection: close

By specifying the “HTTP” protocol, the request having the URL “www.hw-plattform/winac/index” is addressed to the device having the port number 80 of the host having the designation “hw-plattform.de”, i.e., the request is transmitted to the device (E). The device (E) then evaluates the “path component” of the URL. Here, this path component is “/winac” and the addressing component “www.hw-plattform.de” of the host header is not used for selecting the destination web server. In a routing table (not shown here) of the device (E), it is specified that all requests which relate to this path information “/winac” should be routed to an IP address at the same hardware platform (HW), in this case to the local host interface having the IP port number 49152, i.e., the web server (WS1) allocated to the application WinAC. Subsequently, the device (E) forwards the request message to this web server (WS1). Naturally, the request could also be routed to another hardware platform (machine). In the present exemplary embodiment, the device (E) also extends its routing tables by one entry which says that any response message of the web server (WS1) to the request just forwarded should be transmitted to the component (i.e., the client) originally sending out the request. However, other approaches are also conceivable which can lead to a correct forwarding of response messages.

As previously described, the web server (WS2) is used as the forwarding destination for those requests which are not correctly addressed in the present exemplary embodiment. In an advantageous embodiment, the web server (WS2) can also represent an alternative destination in those cases in which one of the web servers (WS1, WS3) fails. Such a failure can be detected, for example, by the device (E) when protocol-compliant acknowledgement messages fail to appear during the transmission of data packets (i.e., they time out). In such a scenario, in which redundancies are to be created, it may be advantageous if at least the backup web server (WS2) is installed on another physical machine (hardware platform).

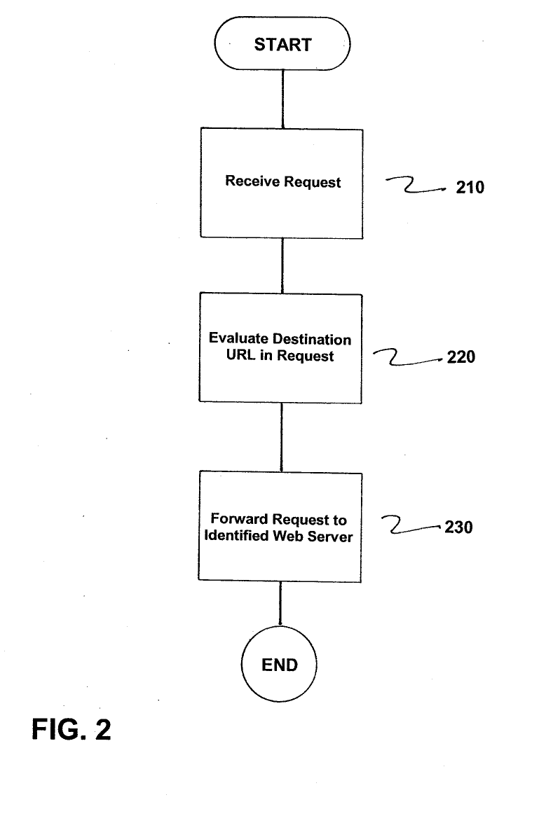

FIG. 2 is a flow chart of a method for distributing and forwarding requests to a plurality of web servers in an industrial automation arrangement in accordance with the invention. The method comprises receiving, at a device, a request addressed to a public port, as indicated in step 210. A destination URL contained in the request is evaluated by the device, as indicated in step 220. Here, the device identifies one of the plurality of web servers as a destination of the request by a path component of the destination URL. The request is then forwarded from the device to the one of the plurality of web servers identified by the path component, as indicated in step 230.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A device for distributing and forwarding requests to a plurality of web servers in an industrial automation arrangement,
wherein the device is configured to receive requests addressed to a public port, each of said plural web servers being addressable by at least one local address and by one port number;
wherein the device is configured to evaluate destination URLs of the received requests, in which each request of the received requests can contain a same host header and server addressing components of the destination URLs can be identical, and a path component of a destination URL of each request defines one of said plural web servers; and
wherein the device is configured to forward each of the received requests to the one of said plural web servers defined by the path component.

2. The device as claimed in claim 1, wherein the device is further configured to forward the requests unchanged to the one of said plural of the web servers defined by the path component.

3. The device as claimed in claim 1, wherein the at least one local address used for addressing said plural web servers identifies one of private and dynamic ports.

4. The device as claimed in claim 1, wherein some or all of said plural web servers are installed on a common hardware platform.

5. The device as claimed in claim 1, wherein the device is installed on a common hardware platform with some or all of said plural web servers.

6. The device as claimed in claim 1, wherein the public port is an IP port having a port number of 80.

7. The device as claimed in claim 1, wherein the device is further configured to forward those requests which do not or do not unambiguously provide for addressing by the path component of the destination URL to a predefined one of said plural web servers.

8. The device as claimed in claim 1, wherein the device is further configured to forward response messages of said plural web servers to a network, the response messages being responses to requests previously forwarded to said plural web servers used to receive the request previously forwarded.

9. A method for distributing and forwarding requests to a plurality of web servers in an industrial automation arrangement, comprising:
receiving, at a device, a request addressed to a public port;
evaluating, by the device, a destination URL contained in the request, the device identifying one of said plural web servers as a destination of the request by a path component of the destination URL; and
forwarding, from the device, the request to the one of said plural web servers identified by the path component.
